(19) United States
(12) Patent Application Publication
(10) Pub. No.: US 2011/0045149 A1
(43) Pub. Date: Feb. 24, 2011

(54) Electronic Roasting System, Method Implementing the System and Roasting Tool for the Same

(76) Inventor: Chien-Yu Lee, Hsinchu City (TW)

Correspondence Address: Flash Intellectual Property, Inc.;Attn. Cheng-Ju Chiang, P.O. Box 766, Chino, CA, 91708, US

(21) Appl. No.: 12/860,678

(22) Filed: Aug. 20, 2010

(30) Foreign Application Priority Data
Aug. 20, 2009 (TW) 098128108
Jun. 7, 2010 (TW) 099118465

(51) Int. Cl. A47J 37/07; A47J 27/00; A23L 1/01

(52) U.S. Cl. 426/233; 99/329 R; 99/450

(57) ABSTRACT

An electronic roasting system, a method implementing the system, and a roasting tool for the same are disclosed. The electronic roasting system includes at least one roasting tool, a grill body supporting the roasting tool, at least one mechanical unit, a processing unit, an electrical control unit and an information output/input unit. The electrical control unit is utilized for controlling the at least one mechanical unit. The information output/input unit is provided for presetting control information. According to the preset control information, the processing unit can programmably control movement of the at least one mechanical unit so as to lead the roasting tool to rotate.

### TECHNICAL FIELD OF THE INVENTION

The present invention relates to an electronic roasting system, a method implementing the electronic roasting system and a roasting tool for the same, and more particularly, to an electronic roasting system and a method implementing the system, which are used for driving at least one roasting tool to rotate according to preset control information.

### BACKGROUND OF THE INVENTION

During a traditional manual-roasting process, foods are anticipatively placed into or on a roasting tool, such as a roasting mesh for barbecue. Then, the roasting mesh is put on a grill over a fire pit which supplies a heating energy to roast the foods by way of burning the woods, charcoals or gases. However, a user constantly has to manually flip the roasting mesh and pay his/her attention to the food appearance and its required cooking time during the roasting process, in order to prevent the foods from being rapidly scorched. If there is a plurality of roasting meshes with the foods to roast on the grill at the same time, it will be difficult to pay attention to the food doneness on each one of the roasting meshes. If the roasting is just for a personal leisure activity, the scorch of the foods may not be cared by itself. However, if the roasting has to be professional for a business, as done by a barbecue restaurant, such a scorched food cannot be served to the customers. To prevent the afore-manner that the being-roasted foods become scorched, the roasting meshes have to be constantly flipped by manual for each interval and are paid attention to in an appearance and cooking time of the foods. Under this manner, it might invoke a laboriousness, costliness and time-consuming.

Further, a heating source, such as the woods, charcoals or gases, is usually placed in a bottom of the grill, and therefore a heating energy can be generated by burning the woods, charcoal or gases. However, such a heating energy may be unevenly supplied for the grill, every bunch of wood or charcoal may not be equal volume and a burning time for each is different. In another example that the heating source is a gas tank, when the gases stored in the gas tank are used up, the amount of heating energy provided by the gas tank may become lowered, suddenly. Under the manner, the foods may need different roasting time due to the unstable heating energy provided by the heating sources. As a result, the user has to depend on his personal experiences or speculation to adjust a roasting period before/after the roasting meshes are flipped for roasting different sides of the foods, according to different conditions of the heating energy provided, currently. In theory, the roasting period has to be shortened when the heating energy is provided higher. In contrast, the roasting period has to be extended when the heating energy is provided lower. However, since the supplying amount of heating energy cannot be accurately possessed, it is difficult to decide an accurate roasting period before/after flipping the meshes for the user. The problems of producing scorched foods or uncooked foods still occur, usually.

Therefore, there needs a system and/or a method to solve the above-mentioned problems in which unfavorable roasting quality of foods or an uncontrolled roasting period occurs by the traditional manual-roasting method.

### SUMMARY OF THE INVENTION

To withdraw the drawbacks of the aforementioned prior art, a primary objective of the present invention is to provide an electronic roasting system, a method for implementing the electronic roasting system, and a roasting tool for the electronic roasting system, which are capable of automatically controlling a roasting quality according to a preset control information based on a roasting period, a rotation time or a number of experiential values, and/or a roasting temperature feedback.

To accomplish the invention objective, the electronic roasting system according to the present invention comprises at least one roasting tool, a grill body for supporting the at least one roasting tool, at least one mechanical unit disposed on the grill body for connecting and driving the at least one roasting tool to rotate, a processing unit, an electrical control unit, and an information output/input unit. The electrical control unit is electrically coupled to the processing unit, and controls said driving of the least one mechanical unit. The information output/input unit is electrically coupled to the processing unit. The electrical control unit is controlled by the processing unit to drive the at least one mechanical unit according to a control information which is preset via the information output/input unit.

Further, according to the present invention, the method for implementing the electronic roasting system which comprises at least one roasting tool, a grill body supporting the at least one roasting tool, at least one mechanical unit driving the at least one roasting tool to rotate, a processing unit, an electrical control unit electrically coupled to the processing unit, and an information output/input unit electrically coupled to the processing unit comprises the following steps: presetting a control information with relation to at least one roasting tool by the information output/input unit; and controlling the electrical control unit by the processing unit to drive the at least one mechanical unit to move, according to the preset control information, and then the movement of the at least one mechanical unit leads the at least one roasting tool to rotate.

The roasting tool according to one embodiment of the present invention is applied to the aforementioned electronic roasting system. The roasting tool comprises a first mesh and a second mesh. The first mesh has a first side and a second side corresponding to the first side. The second side has a first protruded structure. The second mesh has a third side and a fourth side corresponding to the third side. The fourth side has a second protruded structure. A handle is connected to the second protruded structure. A ring is disposed at the second protruded structure. The first side and the third side are connected to each other. The first protruded structure is inserted into the ring so as to combine the first mesh and the second mesh to be a flat layered mesh when the roasting tool is closed.

Compared with the prior art, the electronic roasting system, the method for implementing the system, and the roasting tool for the electronic roasting system, achieve the goal of automatically and programmably rotating the roasting tool instead of manually rotating the roasting tool.

### BRIEF DESCRIPTION OF THE DRAWINGS

FIG. 1 illustrates a functional block diagram of an electronic roasting system according to a first embodiment of the present invention;

FIG. 2 illustrates a stereographic diagram of the electronic roasting system shown in FIG. 1;

FIGS. 3-5 illustrate the rotation processes of the roasting tools;

FIG. 6 illustrates a functional block diagram of an electronic roasting system according to a second embodiment of the present invention;

FIG. 7 illustrates a functional block diagram of an electronic roasting system according to a third embodiment of the present invention;

FIG. 8 illustrates an embodiment of the information output/input unit in FIG. 1;

FIG. 9A and FIG. 9B illustrate an embodiment of the roasting tool in FIG. 2;

FIG. 10 illustrates a stereographic diagram of an electronic roasting system according to a fourth embodiment of the present invention;

FIG. 11 illustrates a functional block diagram of the fourth embodiment;

FIGS. 12A and 12B illustrate an assembled diagram of the grill body and the control module in the electronic roasting system of FIG. 10;

FIG. 13 illustrates the roasting tool according to another embodiment of the present invention;

FIGS. 14A and 14B illustrate the assembled diagram of the grill body, the roasting tool, and the control module in FIG. 13;

FIG. 15 illustrates a structural diagram of the mechanical unit of the control module;

FIG. 16 illustrates an appearance of the control module in FIG. 11;

FIG. 17 illustrates a flow chart of a method for implementing the electronic roasting system in FIG. 1; and

FIG. 18 illustrates a flow chart of a method for implementing the electronic roasting system in FIG. 10.

### DETAILED DESCRIPTION OF THE INVENTION

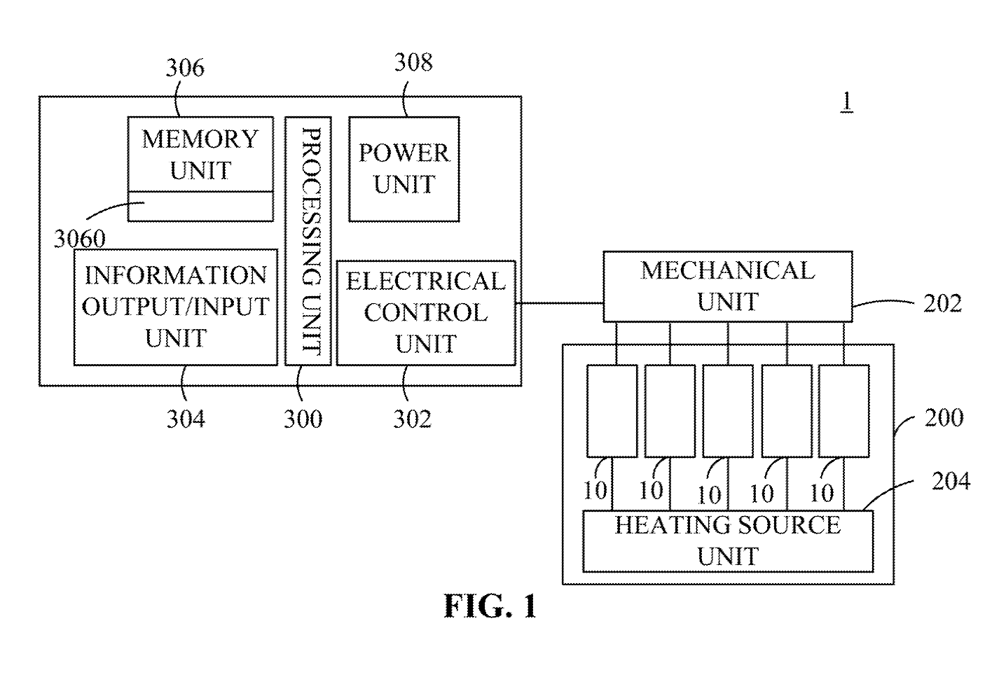

Please refer to FIG. 1, which illustrates a functional block diagram of an electronic roasting system 1 according to a first embodiment of the present invention. The electronic roasting system 1 comprises at least one roasting tool 10 for clamping foods, a grill body 200, a mechanical unit 202, a heating source unit 204, a processing unit 300, an electrical control unit 302, an information output/input unit 304, a memory unit 306, and a power unit 308.

The electrical control unit 302 is electrically coupled to the processing unit 300 and functions as a driving unit for programmably controlling a movement of the mechanical unit 202. The information output/input unit 304 is electrically coupled to the processing unit 300 and can receive a number of control information preset by a user based on a total roasting time and/or a rotation time, an interval time and speed of the at least one roasting tool 10, or a number of experiential values. The memory unit 306 is electrically coupled to the processing unit 300 for storing the control information preset by the information output/input unit 304. The memory unit 306 comprises a control parameter generating unit 3060, such as an executable program, for processing the control information so as to output a control parameter which is capable of being identified by the electrical control unit 302. The power unit 308, which can be at least one battery, a generator, or electricity, is electrically coupled to the processing unit 300 for supplying the required power to the system, including the processing unit 300, the electrical control unit 302, the information output/input unit 304, and the memory unit 306.

The electrical control unit 302 is controlled by the processing unit 300 to programmably control the mechanical unit 202 to move according to the control parameter which is outputted by the control parameter generating unit 3060 of the memory unit 306, so that the movement of the mechanical unit 202 can lead the roasting tools 10 to rotate.

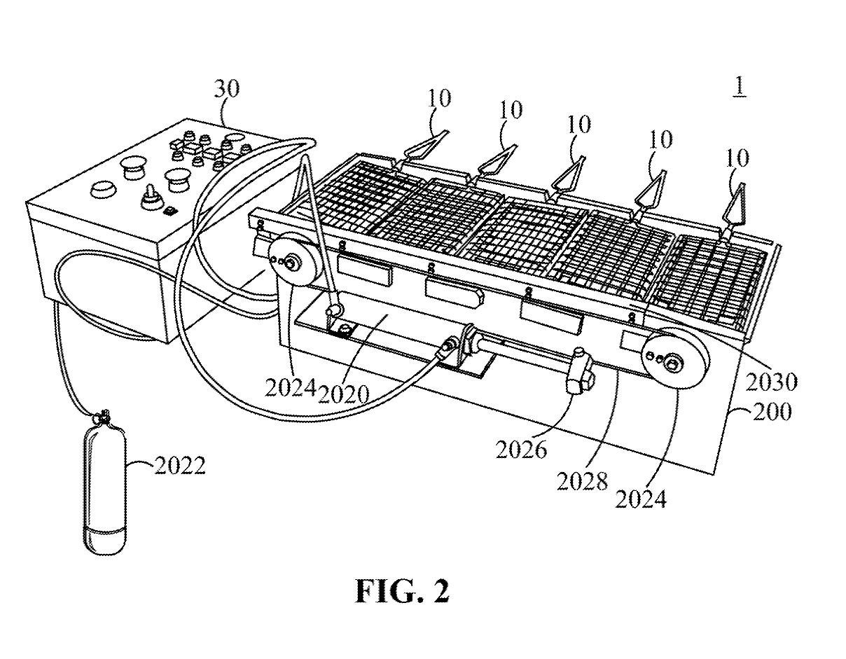

Please refer to FIG. 2, which illustrates a stereographic diagram of the electronic roasting system 1 shown in FIG. 1. The grill body 200 is constructed in a box shape and has an upper opening. Two edges corresponding to the upper opening are utilized for supporting two opposite sides of the roasting tools 10 in a longitudinal direction. The mechanical unit 202 is disposed on an outer side surface or an appropriate position of the grill body 200 for driving the roasting tools 10 to rotate, such as turning them over and over. The heating source unit 204 (as shown in FIG. 1) is disposed on a bottom of the grill body 200 and under/beside the roasting tools 10. The heating source unit 204 may be the woods, charcoals or combustible gas for supplying a heating energy to the roasting tools 10.

In the present embodiment, the mechanical unit 202 comprises a pressure cylinder 2020, a high pressure gas unit 2022, two rollers 2024, an interconnected line 2028, and an interconnected support 2030. The pressure cylinder 2020 is connected to the electrical control unit 302 (as shown in FIG. 1), and the pressure cylinder 2020 has an end disposed with a movable shaft 2026. The high pressure gas unit 2022 provides a high pressure gas and is connected to the pressure cylinder 2020 via the electrical control unit 302 (as shown in FIG. 1). The two rollers 2024 are rotatably disposed on an outer wall of the grill body 200. The interconnected line 2028 is wound around a partial circumference of each of the rollers 2024 and connected to a terminal of the movable shaft 2026. The interconnected support 2030 is respectively connected to both the rollers 2024 and the roasting tools 10.

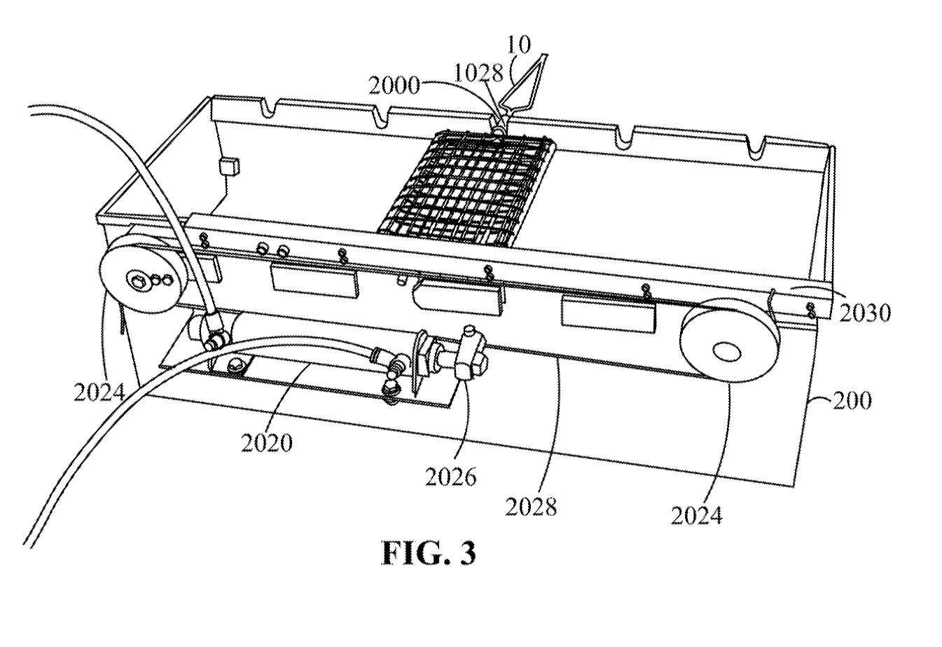

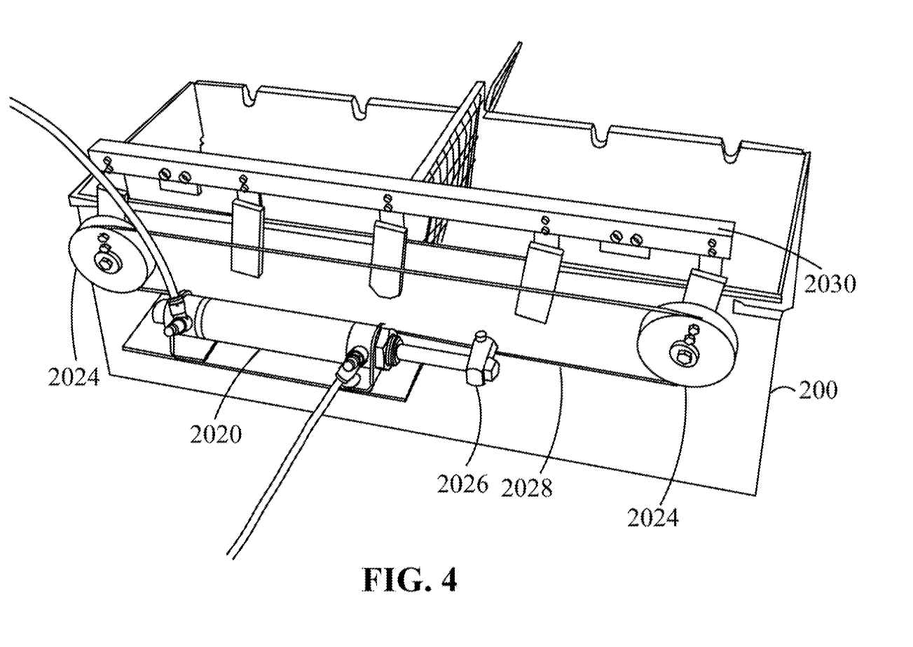

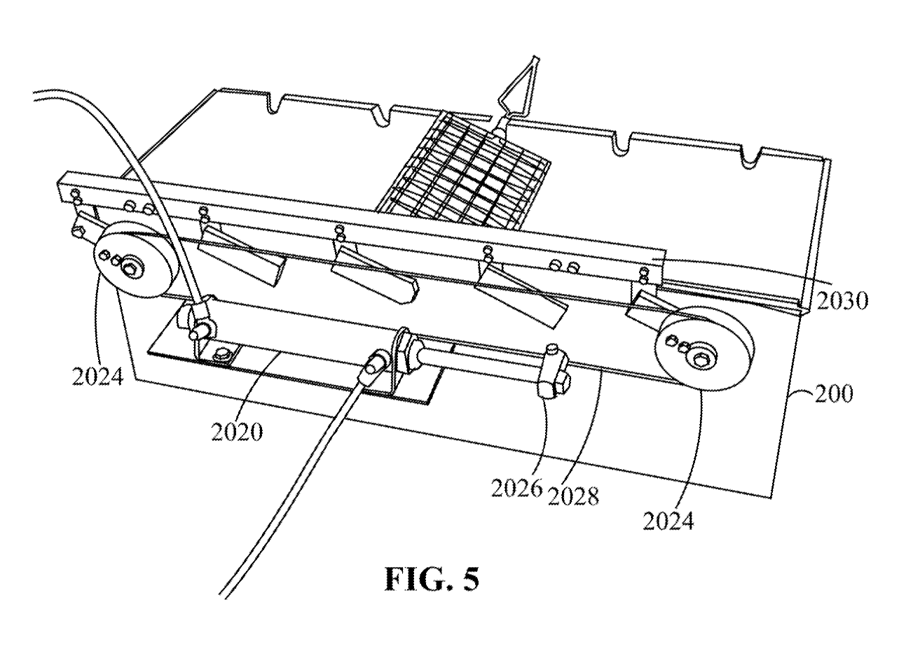

When the electronic roasting system 1 is in operation, the electrical control unit 302 (as shown in FIG. 1) controls a air volume entering the pressure cylinder 2020 to push the movable shaft 2026 to move. The moved movable shaft 2026 leads the rollers 2024 to rotate via the interconnected line 2028, and then the rotated rollers 2024 lead the roasting tools 10 to rotate via the interconnected support 2030. Please refer to FIGS. 3-5, which illustrate the rotation processes of the roasting tools 10. FIG. 3 shows an initial state (i.e. not starting to rotate) of the roasting tools 10 wherein the movable shaft 2026 disposed at the end of the pressure cylinder 2020 is not moved. Then as shown in FIG. 4, the user inputs the control information, such as a total roasting time, a rotation time or an interval time of the roasting tools 10, to the processing unit 300 (as shown in FIG. 1); then the electrical control unit 302 (as shown in FIG. 2) controls a gas valve (not shown) of the high pressure gas unit 2022 (as shown in FIG. 2) to increase a gas pressure in the pressure cylinder 2020 so that the movable shaft 2026 of the pressure cylinder 2020 is pushed to move to its right side and leads the interconnected line 2028 to move. The moved interconnected line 2028 leads the rollers 2024 to rotate along a counter-clockwise direction. The rotated rollers 2024 lead the interconnected support 2030 to move so that as shown in FIG. 4, the roasting tools 10 are driven to turn over by one-half state by the interconnected support 2030. As shown in FIG. 5, the roasting tools 10 are driven by the interconnected support 2030 to turn over to each half side as each complete rotation. In summary, the pressure cylinder 2020 drives the roasting tools 10 to rotate by way of transforming the linear movement of the interconnected line 2028 into a circular movement of the rollers 2024.

In the rotation processes as shown in FIGS. 3-5, the required rotation power of the roasting tools 10 is supplied by the pressure cylinder 2020 and the high pressure gas unit 2022. In another embodiment, a hydraulic cylinder can be substituted for the pressure cylinder 2020. In another embodiment, a motor (not shown) can be substituted for the pressure cylinder 2020, and therefore the high pressure gas unit 2022 is not needed. When the motor serves as the source of the rotation power, a shaft roller (not shown) is assembled to a shaft of the motor. The interconnected line 2028 is wound around the rollers 2024 and connected to the shaft roller. The electrical control unit 302 (as shown in FIG. 1) controls forward or reverse rotation angles and/or speeds of the motor so that the shaft of the motor drives the roasting tools 10 to rotate via the shaft roller, interconnected line 2028, and the interconnected support 2030. That is, the circular movement of the motor is transferred to the linear movement of the interconnected line 2028. Then, the roasting tools 10 are driven to rotate by transferring the linear movement of the interconnected line 2028 to circular movement of the rollers 2024.

As shown in FIG. 2, the processes that the roasting tools 10 are driven to rotate clockwise by the rollers 2024 are just the opposite to the processes that the roasting tools 10 are driven to rotate counter-clockwise by the rollers 2024. For example, the electrical control unit 302 controls the gas valve of the high pressure gas unit 2022 to pull the movable shaft 2026 of the pressure cylinder 2020 to move to its left side and leads the interconnected line 2028 to reversely move. The reversely-moved interconnected line 2028 leads the rollers 2024 to rotate along a clockwise direction. The clockwise-rotated rollers 2024 lead the interconnected support 2030 to reversely move so that the roasting tools 10 are driven to turn over to the initial state by the interconnected support 2030.

It is noted that the mechanical unit 202 drives multiple roasting tools 10 to rotate simultaneously as shown in FIG. 1. In another embodiment, the electronic roasting system 1 may comprise a plurality of mechanical units 202, for example, five mechanical units 202, and each one of the mechanical units 202 is corresponding to each one of the roasting tools 10. The mechanical units 202 may drive the roasting tools 10 to rotate synchronously or asynchronously under the control of the electrical control unit 302. In another embodiment, a plurality of roasting tools 10 are driven to rotate by a plurality of mechanical units 202. For example, four roasting tools 10 are driven by two mechanical units 202. One mechanical unit 202 may drive two roasting tools 10 to rotate synchronously or asynchronously under the control of the electrical control unit 302.

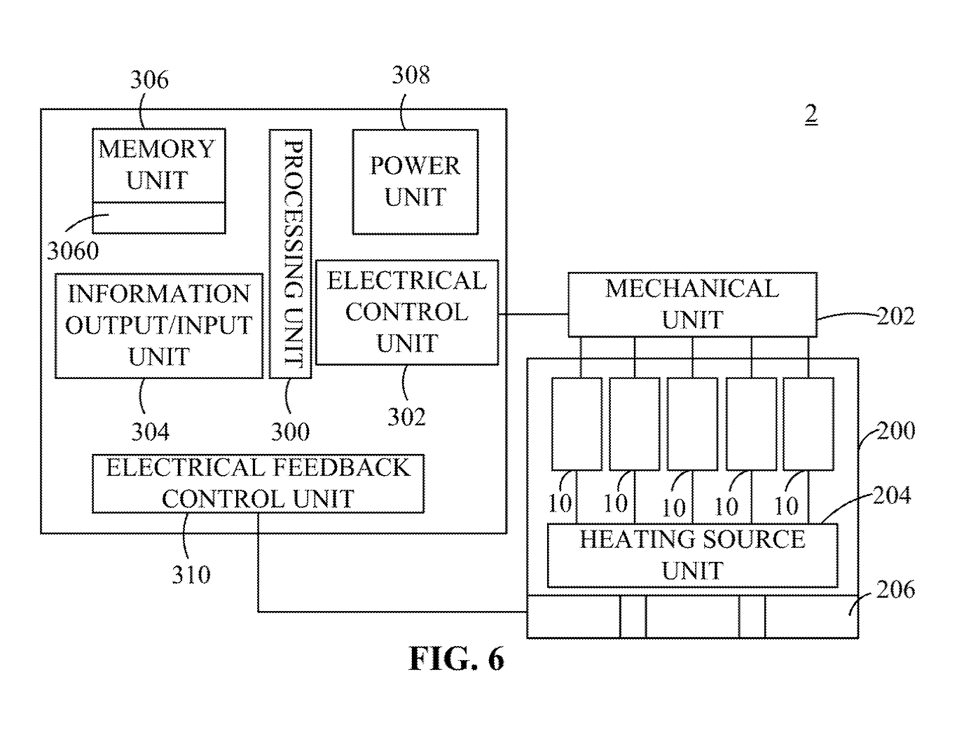

Please refer to FIG. 6, which illustrates a functional block diagram of an electronic roasting system 2 according to a second embodiment of the present invention. Compared with the first embodiment as shown in FIG. 1, the second embodiment further comprises at least one temperature sensing unit 206 and an electrical feedback control unit 310 electrically coupled to the processing unit 300. The temperature sensing unit 206 is utilized for sensing a heating temperature generated from the heating source unit 204 in the grill body 200. The electrical feedback control unit 310 is electrically coupled to the processing unit 300 and receives information such as the heating temperature. The information of the heating temperature is sensed by the temperature sensing unit 206 or generated by the heating source unit 204. When the processing unit 300 receives the information of the heating temperature, the control parameter generating unit 3060 of the memory unit 306 automatically programs and adjusts the control information originally preset by the user. For example, the memory stores information of temperature versus rotation time in advance. The control parameter generating unit 3060 automatically programs and adjusts the following accordingly: shortening the rotation time of the roasting tools 10 when the heating temperature is higher, and extending the rotation time of the roasting tools 10 when the heating temperature is lower.

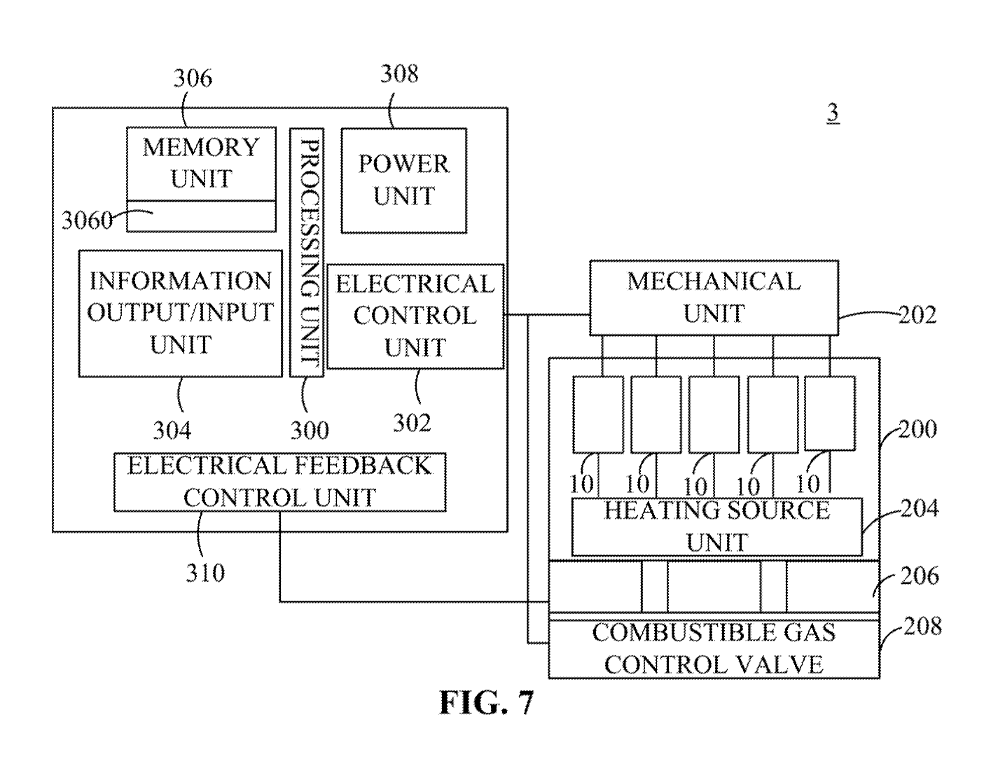

Please refer to FIG. 7, which illustrates a functional block diagram of an electronic roasting system 3 according to a third embodiment of the present invention. In the third embodiment, the heating source unit 204 is combustible gas. Compared with the second embodiment, the third embodiment further comprises a combustible gas control valve 208 connected to another valve driving unit (not shown) of the electrical control unit 302. When the processing unit 300 receives the heating temperature information, the control parameter generating unit 3060 of the memory unit 306 automatically programs and adjusts an outflow volume of the combustible gas control valve 208 and/or the control information preset by the user. For example, the control parameter generating unit 3060 automatically programs and adjusts the followings: supplying a higher heating energy and deciding a longer rotation time when starting to roast, and supplying a lower heating energy and deciding a shorter rotation time to prevent the foods from being scorched after roasting some time.

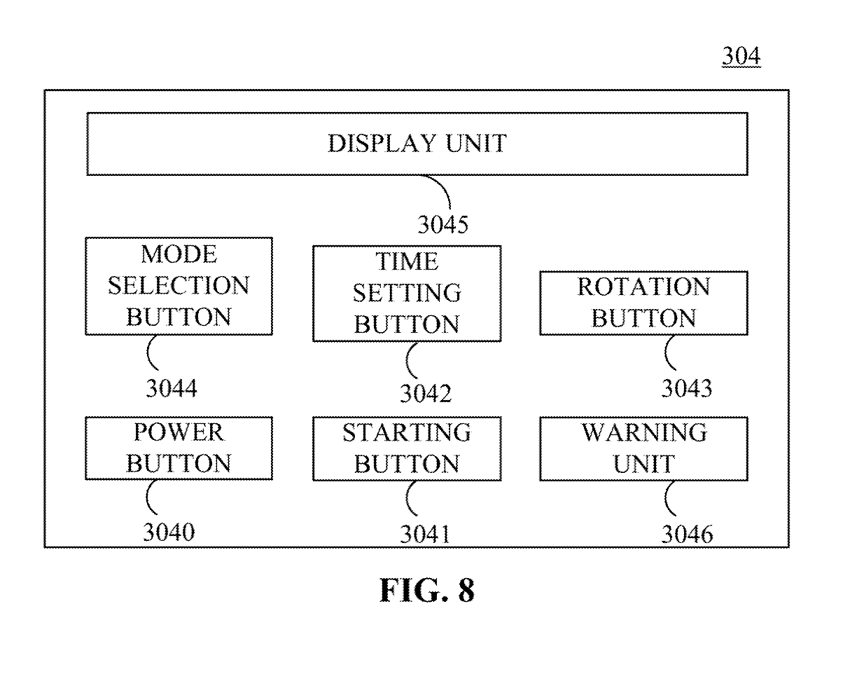

Please refer to FIG. 8, which illustrates an embodiment of the information output/input unit 304 in FIG. 1. The information output/input unit 304 comprises a control panel having at least a plurality of output subunits and a plurality of input subunits. The input subunits may include but not limited to a power button 3040, a starting button 3041, at least one time setting button 3042, a rotation button 3043, and a mode selection button 3044. The output subunits may include but not limited to a display unit 3045 and a warning unit 3046. The power button 3040 is utilized for powering the electronic roasting system 1. The starting button 3041 is utilized for setting to start or stop. The time setting button 3042 is utilized for setting control information, for example, a total roasting time of 180 seconds or a rotation time of the roasting tools 10 (as shown in FIG. 1) every 10 seconds. The rotation button 3043 is utilized to rotate the roasting tools 10 (as shown in FIG. 1), immediately. The mode selection button 3044 is utilized for selecting any one of a plurality of automatic modes. According to different foods, different total roasting time and rotation time of the roasting tools 10 are pre-stored in each difference one of the automatic modes. For example, the automatic modes as implemented in programs are stored in the control parameter generating unit 3060 of the memory unit 306. The display unit 45 including, such as a plurality of light emitting diodes, is utilized for displaying the preset total roasting time and roasting time of the roasting tools 10. The warning unit 3046 is utilized for warning end of the total roasting time. In another embodiment, the information output/input unit 304 further comprises a stop button (not shown) to stop rotating of the roasting tools 10.

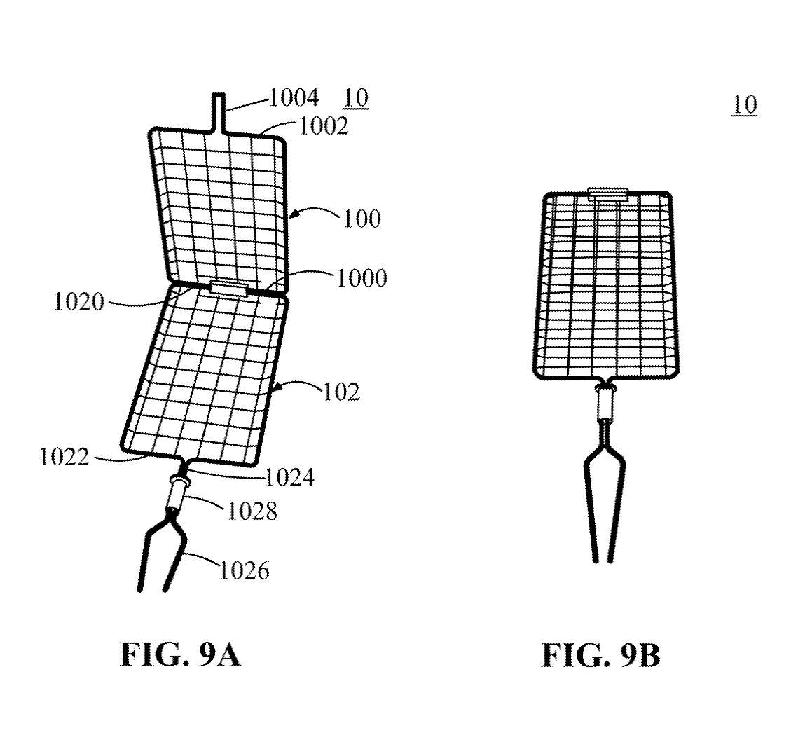

Please refer to FIG. 9A and FIG. 9B, which illustrate an embodiment of the roasting tool 10 in FIG. 2. As shown in FIG. 9A, the roasting tool 10 comprises a first mesh 100 and a second mesh 102. The first mesh 100 has a first side 1000 and a second side 1002 corresponding to the first side 1000. The second side 1002 has a first protruded structure 1004. The second mesh 102 has a third side 1020 and a fourth side 1022 corresponding to the third side 1020. The fourth side 1022 has a second protruded structure 1024, a handle 1026 connected to the second protruded structure 1024, and a ring 1028 disposed at the second protruded structure 1024. The first side 1000 and the third side 1020 are connected to each other. The first protruded structure 1004 is inserted into the ring 1028 so as to combine the first mesh 100 and the second mesh 102 to be a flat layered mesh shown in FIG. 9B when the roasting tool 10 is closed. An inner diameter of the ring 1028 is smaller than a size of the handle 1026 so that the ring 1028 may be stably fixed into the second protruded structure 1024. The ring 1028 is appropriately fitted at a groove 2000 formed at the grill body 200 (as shown in FIG. 3) when the roasting tool 10 is rotating. The groove 2000 is disposed at the side opposite to the interconnected support 2030. Tow sides of the roasting tool 10 in the longitudinal direction are respectively fixed at the interconnected support 2030 and the groove 2000.

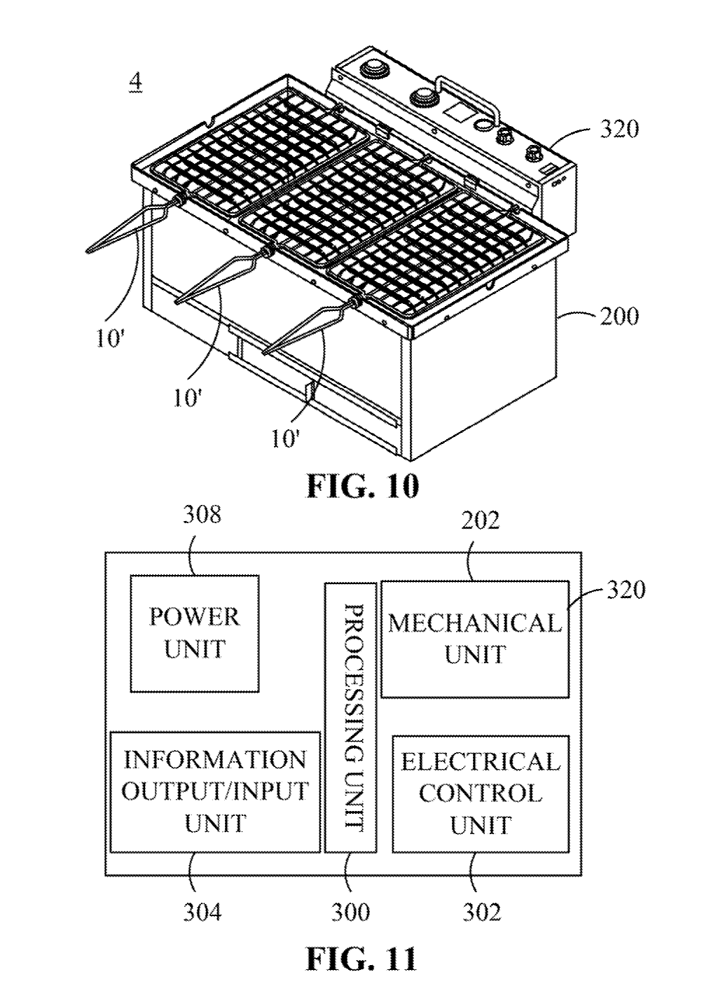

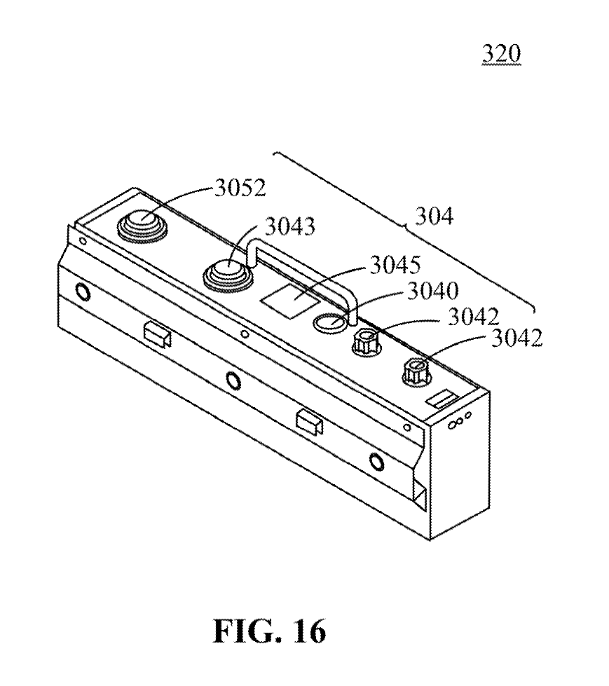

Please refer to FIGS. 10 and 11. FIG. 10 illustrates a stereographic diagram of an electronic roasting system 4 according to a fourth embodiment of the present invention. FIG. 11 illustrates a functional block diagram of the fourth embodiment. In the first, second, and third embodiments, the mechanical unit 202 is separated from the other units and disposed at the grill body 200 independently. In the fourth embodiment, the mechanical units 202, the processing unit 300, the electrical control unit 302, the power unit 308, and the information output/input unit 304 are integrated to be a control module 320. The control module 320 which integrates the above-mentioned units is constructed in a box structure and has a metallic case for protecting and covering the control module 320 (as shown in FIG. 16). A goal of independently integrating the control module 320 is detachably assembled at the grill body 200 for being conveniently portable. In addition, the overall size of the control module 320 is allowed to be appropriately contained in the containing space, i.e. the space containing wood charcoal.

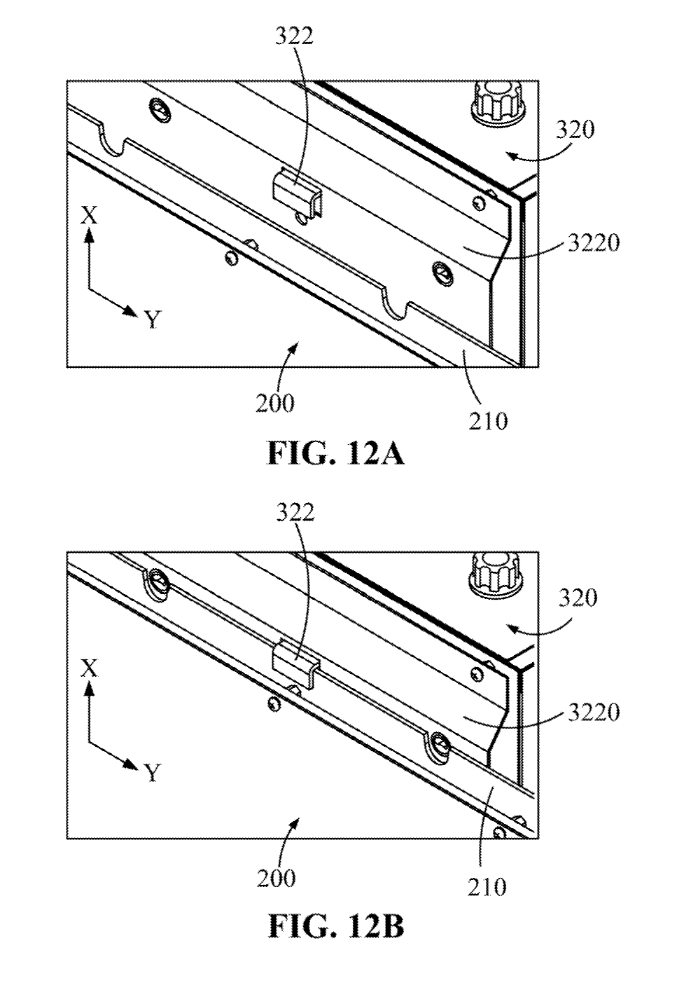

Please refer to FIGS. 12A and 12B, which illustrate an assembled diagram of the grill body 200 and the control module 320 in the electronic roasting system 4 of FIG. 10. A plurality of fixed structures 322 is formed in an inverted L-shape and disposed (for example, formed by punching) on an outer surface of the control module 320. Each one of the fixed structures 322 comprises a horizontal subunit and a vertical subunit. In the present embodiment, a separating plate 3220 is disposed on an outer side wall of the metallic case of the control module 320 for separating the control module 320 and the grill body 200 so as to form a specific distance between the control module 320 and the grill body 200. The plurality of fixed structures 322 may be disposed on a side wall of the separating plate 3220 by punching.

In assembly shown in FIGS. 12A and 12B, the control module 320 with the fixed structures 322 are downwardly disposed toward the top of the grill body 200 along an x-axis so that the fixed structures 322 are buckled on a side wall 210 of the grill body 200. That is, the horizontal subunits of the fixed structures 322 spraddle the edge of the side wall 210 of the grill body 200, and the combination of the control module 320 and the grill body 200 is completely fixed. As shown in FIGS. 10 and 12B, the control module 320 hangs at the side wall 210 of the grill body 200. In contrary, when disassembling, the control module 320 and the fixed structures 322 are moved upwardly from the top of the grill body 200 along the x-axis. Then, the fixed structures 322 may be separated from the side wall 210 of the grill body 200, and the control module 320 and the grill body 200 are disassembled. In addition, screws may be utilized for strengthening the assembling between the control module 320 and the grill body 200.

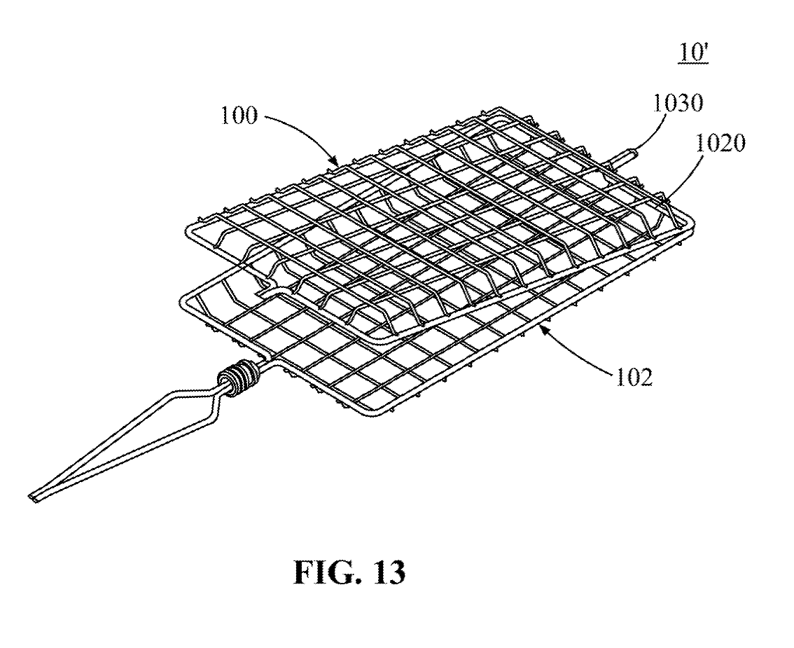

Please refer to FIG. 13, which illustrates the roasting tool 10′ according to another embodiment of the present invention. The roasting tool 10′ is utilized for adapting to the electronic roasting system 4 in FIG. 10. Compared with the roasting tool 10 in FIGS. 9A and 9B, the third side 1020 of the second mesh (i.e. a non-fixed mesh) 102 of the roasting tool 10′ has a third protruded structure 1030. The third protruded structure 1030 is protruded outwardly and utilized for assembling with the control module 320 in FIG. 10 (will be described later).

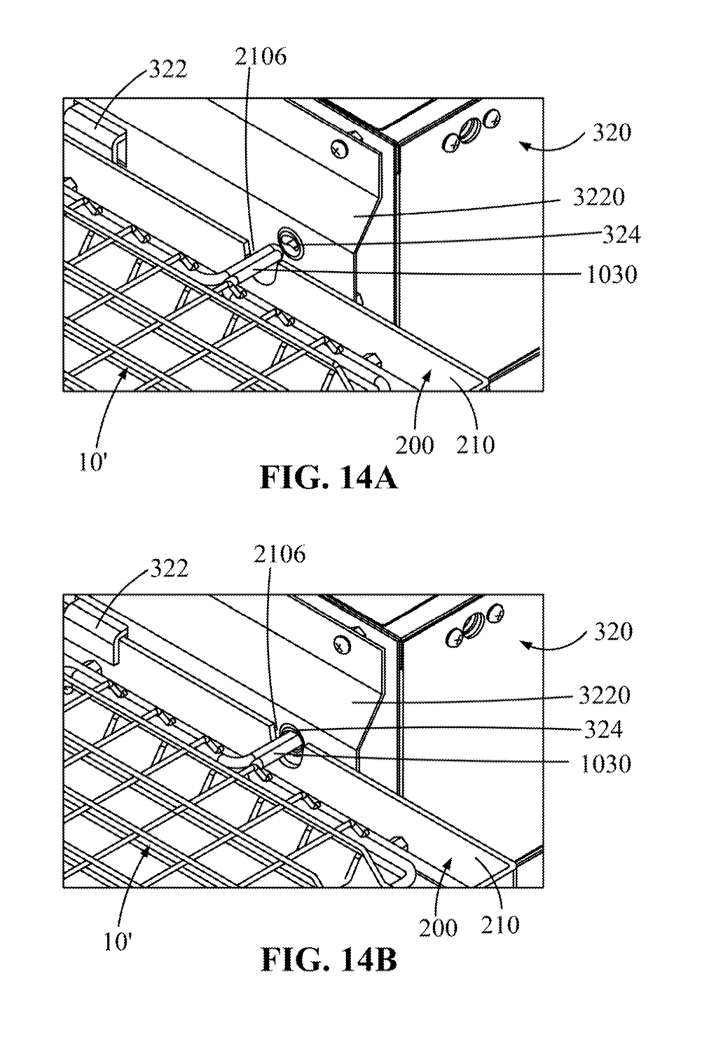

Please refer to FIGS. 10, 14A, and 14B. FIGS. 14A and 14B illustrate the assembled diagram of the grill body 200, the roasting tool 10′, and the control module 320 in FIG. 13. As shown in FIG. 14, a plurality of holes 324 is formed on an outer surface of the control module 320 or on the separating plate 3220. A plurality of indentations 2106 corresponding to the holes 324 is formed on the edge of the side wall 210 of the grill body 200.

At the time of assembly, the third protruded structure 1030 of each roasting tool 10′ is horizontally inserted in the corresponding hole 324 so as to finish the assembled of the roasting tool 10′ and the control module 320. When the roasting tool 10′ and the control module 320 are assembled, the fixed structures 322 of the control module 320 buckle on the side wall 210 of the grill body 200 (as shown in FIG. 14B).

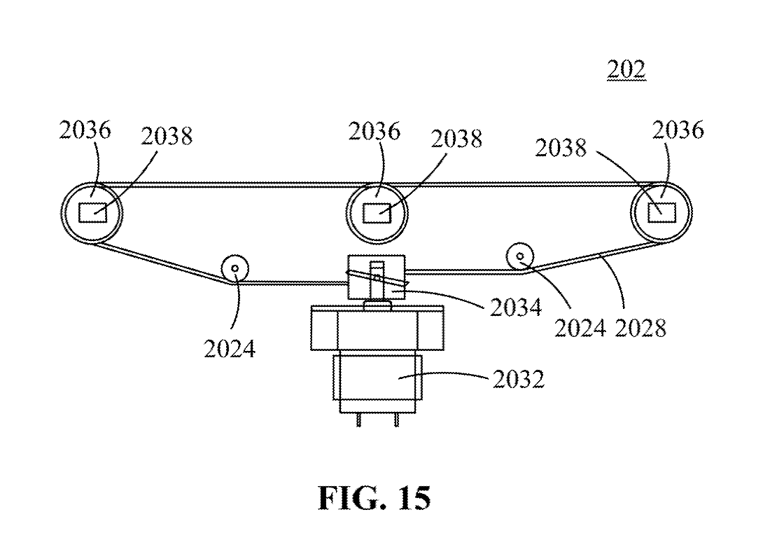

Please refer to FIGS. 11 and 15. FIG. 15 illustrates a structural diagram of the mechanical unit 202 of the control module 320. The mechanical unit 202 comprises a control motor 2032, a shaft roller 2034 disposed at the shaft of the control motor 2032, at least one roller 2024, at least one roasting tool roller 2036, an interconnected wire 2028 wound around the at least one roller 2024 and the at least one roasting tool roller 2036 and connected to the shaft roller 2034. In the present embodiment, there are three roasting tool rollers 2036 corresponding to the three roasting tools 10′ shown in FIG. 10. Each roasting tool roller 2036 has a rectangular hole 2038. After the third protruded structure 1030 of each roasting tool 10′ has been inserted in the corresponding hole 324 of the control module 320 (as shown in FIGS. 14A and 14B), the third protruded structure 1030 of the roasting tool 10′ may be fixed in the corresponding rectangular hole 2038 of the roasting tool roller 2036. The electrical control unit 302 (as shown in FIG. 11) drives the shaft of the control motor 2032 to rotate, and the shaft of the control motor 2032 leads the shaft roller 2034 to rotate. Then the shaft roller 2034 leads the rollers 2024 and the roasting tool rollers 2036 to rotate via the interconnected wire 2028 at a specific speed. Finally, the rectangular holes 2038 of the roasting tool rollers 2036 and the third protruded structures 1030 positioned in the rectangular holes 2038 lead the roasting tools 10′ to rotate based on the axis of the third protruded structure 1030 at the same speed.

It is noted that the rollers 2024 may be omitted in another embodiment. Instead, the control motor 2032 leads the roasting tool rollers 2036 via the interconnected wire 2028. Further, a roasting tool 10′ may be controlled to rotate by a control motor 2032 in another embodiment. That is, each roasting tool 10′ may be controlled independently without synchronously rotating or rotating at the same speed.

Please refer to FIG. 16, which illustrates an appearance of the control module 320 in FIG. 11. The information output/input unit 304 comprises a control panel having at least a plurality of output subunits and a plurality of input subunits. The input subunits may include but not limited to a power button 3040, a two-segment time setting button 3042, a rotation button 3043, and a pause button 3052. The output subunits may include but not limited to a display unit 3045. The power button 3040 is utilized for powering the electronic roasting system 1. The two-segment time setting button 3042 is utilized for setting control information, for example, a rotation time of the roasting tools 10′ (as shown in FIG. 10). The range of the rotation time of the roasting tools 10′ is between 0 second and 99 seconds. The pause button 3052 is utilized to pause the rotation of the roasting tools 10′ (as shown in FIG. 10) immediately. The rotation button 3043 is utilized for immediately starting to rotate the roasting tools 10′. The display unit 3045 is utilized for displaying the rotation time of the roasting tool 10′ and/or other control information.

In the present invention, the processing unit 300 of the electrical control unit 320 in FIG. 11 is at least one selected from a group consisting of a micro processor, a micro controller, a complex programmable logic device (CPLD), an application specific integrated circuit (ASIC), and a digital signal processor (DSP).

The power unit 308 of the control module 320 is utilized for supplying power for the processing unit 300, the electrical control unit 302, the information output/input unit 304, and the mechanical unit 202. In one preferred embodiment, the power unit 308 may be at least one battery for the convenience of portability and use.

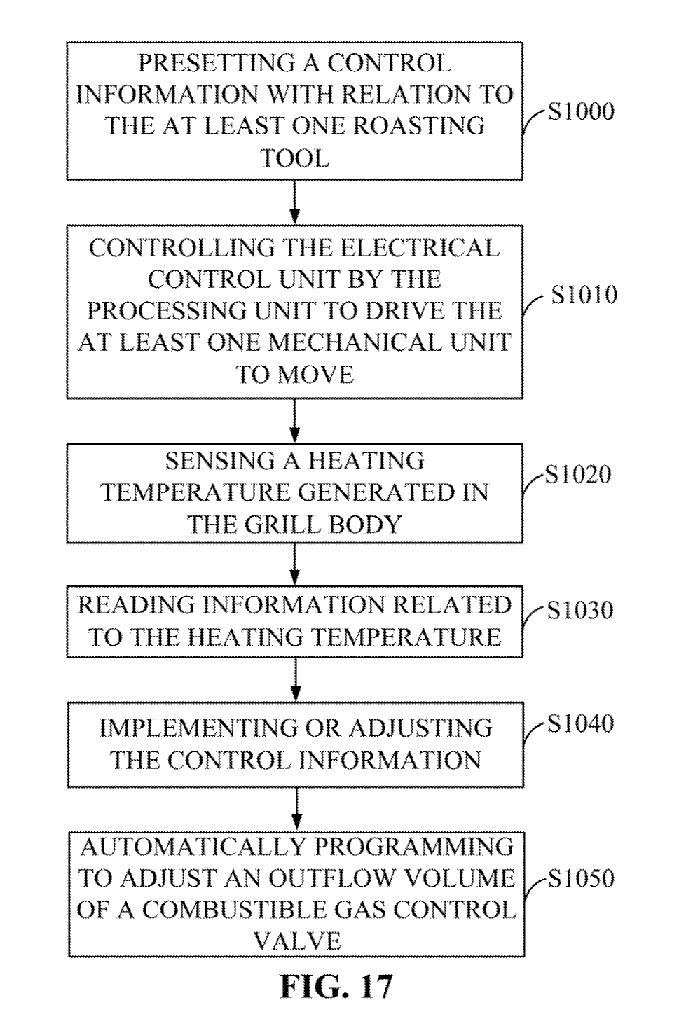

Please refer to FIGS. 1 and 17. FIG. 17 illustrates a flow chart of a method for implementing the electronic roasting system 1 in FIG. 1. The electronic roasting system 1 comprises at least one roasting tool 10, a grill body 200 supporting the at least one roasting tool 10, at least one mechanical unit 202 driving the at least one roasting tool 10 to rotate, a processing unit 300, an electrical control unit 302 electrically coupled to the processing unit 300, and an information output/input unit 304 electrically coupled to the processing unit 300. The method comprises the following steps.

In step S1000, a control information with relation to the at least one roasting tool 10, such as a rotation information of the at least one roasting tool 10 or an automatic mode, is preset by the output/input 304. For example, a rotation time of the at least one roasting tool 10 is preset by the at least one time setting button of the information output/input unit 304, or one of different automatic modes is selected by a mode selecting button. Each one of the automatic modes contains a total roasting time and a rotation interval time of the at least one roasting tool 10.

In step S1010, the electrical control unit 302 is controlled by the processing unit 300 to drive the least one mechanical unit 202 to move, according to the control information, and then the movement of the at least one mechanical unit 202 leads the at least one roasting tool 10 to rotate. For example, a plurality of roasting tools 10 is driven to rotate by a plurality of mechanical units 202, wherein one roasting tool 10 is corresponding to one mechanical unit 202. For another example, four roasting tools 10 are driven by two mechanical units 202. One mechanical unit 202 may drive two roasting tools 10 to rotate synchronously or asynchronously under the control of the electrical control unit 302.

Please refer to FIGS. 6 and 17, the method further comprises the following steps.

In step S1020, at least one temperature sensing unit 206 is utilized for sensing heating temperature of the grill body 200.

In step S1030, the processing unit 300 reads an information of the heating temperature via an electrical feedback control unit 310.

In step S1040, a control parameter generating unit 3060 of the memory unit 306 implements or adjusts the control information via the processing unit 300 according to the information of the heating temperature.

Please refer to FIGS. 7 and 17, the method further comprises the following step.

In step S1050, the control parameter generating unit 3060 automatically programs to adjust an outflow volume of a combustible gas control valve 208 disposed on the grill body 200.

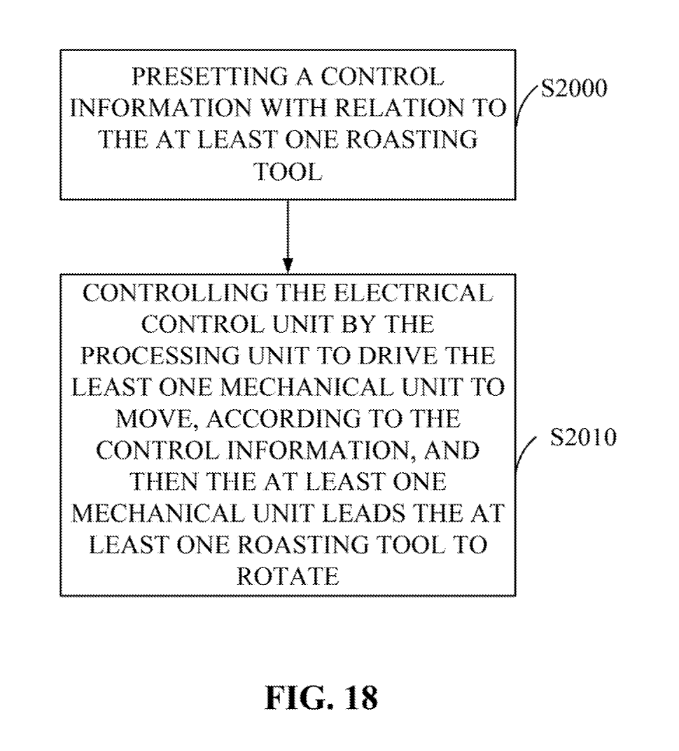

Please refer to FIGS. 10, 11 and 18. FIG. 18 illustrates a flow chart of a method for implementing the electronic roasting system 4 in FIG. 10. The electronic roasting system 4 comprises at least one roasting tool 10′, a grill body 200 supporting the at least one roasting tool 10′, at least one mechanical unit 202 driving the at least one roasting tool 10′, a processing unit 300, an electrical control unit 302 electrically coupled to the processing unit 300, and an information output/input unit 304 electrically coupled to the processing unit 300. The method comprises the following steps.

In step S2000, a control information with relation to the at least one roasting tool 10′, such as a rotation interval time of the at least one roasting tool 10′, is preset by the information output/input unit 304.

In step S2010, the electrical control unit 302 is controlled by the processing unit 300 to drive the least one mechanical unit 202 according to the control information, and then the at least one mechanical unit 202 leads the at least one roasting tool 10′ to rotate. For example, a plurality of roasting tools 10′ are driven to rotate by a plurality of mechanical units 202, wherein one roasting tool 10′ is corresponding to one mechanical unit 202. For example, four roasting tools 10′ are driven by two mechanical units 202. One mechanical units 202 may drive two roasting tools 10′ to rotate synchronous or asynchronously under the control of the electrical control unit 302.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An electronic roasting system, comprising:
at least one roasting tool;
a grill body for supporting the at least one roasting tool;
at least one mechanical unit connecting and driving the at least one roasting tool to rotate;
a processing unit;
an electrical control unit electrically coupled to the processing unit and controlling said driving of the mechanical unit; and
an information output/input unit electrically coupled to the processing unit, wherein the electrical control unit is controlled by the processing unit to drive the least one mechanical unit according to a control information which is preset via the information output/input unit.

2. The electronic roasting system of claim 1, wherein the preset control information comprises a rotation time of the at least one roasting tool and/or at least one automatic mode.

3. The electronic roasting system of claim 2, wherein the information output/input unit comprises:
at least one input subunit where a total roasting time and/or the rotation time of the at least one roasting tool is preset; and
an output subunit where the total roasting time and/or the rotation time of the at least one roasting tool preset by the input subunit is displayed.

4. The electronic roasting system of claim 2, wherein the information output/input unit further comprises a mode selection subunit for selecting the at least one automatic mode where a total roasting time and a rotation time of the at least one roasting tool are contained.

5. The electronic roasting system of claim 1, wherein the at least one mechanical unit is disposed on the grill body which is formed with at least one groove.

6. The electronic roasting system of claim 5, wherein the at least one mechanical unit comprises:
a pressure cylinder connected to the electrical control unit, wherein the pressure cylinder has an end disposed with a movable shaft;
two rollers rotatably disposed on the grill body;
an interconnected line wound around the rollers and connected to the movable shaft; and
an interconnected support respectively connected to both the rollers and the at least one roasting tool, wherein when the electrical control unit drives the movable shaft of the pressure cylinder to move, the moved movable shaft leads the rollers to rotate via the interconnected line, and then the rotated rollers lead the at least one roasting tool to rotate via the interconnected support.

7. The electronic roasting system of claim 5, wherein the at least one mechanical unit comprises:
a motor connected to the electrical control unit and having a shaft;
a shaft roller disposed on the shaft of the motor;
two rotatable rollers;
an interconnected line wound around the rotatable rollers and connected to the shaft roller; and
an interconnected support respectively connected to both the rollers and the at least one roasting tool, wherein when the electrical control unit drives the shaft of the motor to move, the moved shaft leads the shaft roller to rotate, the rotated shaft roller leads the rotatable rollers to rotate via the interconnected line, and the rotated rotatable rollers lead the at least one roasting tool to rotate via the interconnected support.

8. The electronic roasting system of claim 1, further comprising a heating source unit disposed on a bottom of the grill body and under/beside the at least one roasting tool, and the heating source unit is used for supplying the at least one roasting tool with a heating energy.

9. The electronic roasting system of claim 8, further comprising:
at least one temperature sensing unit for sensing a heating temperature generated from the heating source unit in the grill body; and
an electrical feedback control unit electrically coupled to the processing unit and receiving an information related to the heating temperature from the at least one temperature sensing unit, and the processing unit automatically adjusting the control information according to the information related to the heating temperature.

10. The electronic roasting system of claim 9, further comprising at least one combustible gas control valve, and the processing unit automatically controlling an outflow volume of the combustible gas control valve according to the information related to the heating temperature.

11. The electronic roasting system of claim 1, further comprising a heating source unit disposed on a bottom of the grill body and under/beside the at least one roasting tool, and the heating source unit provides a combustible gas.

12. The electronic roasting system of claim 1, further comprising a memory unit electrically coupled to the processing unit for storing the control information preset by the information output/input unit, and the memory unit comprising a control parameter generating unit for processing the preset control information so as to output a control parameter which can be identified by the electrical control unit.

13. The electronic roasting system of claim 1, further comprising a power unit electrically coupled to the processing unit and supplying a power for the system.

14. The electronic roasting system of claim 1, wherein the at least one mechanical unit, the processing unit, the electrical control unit, and the information output/input unit are integrated to be a control module which is detachably assembled to the grill body.

15. The electronic roasting system of claim 14, further comprising a plurality of fixed structures formed in an inverted L-shape and disposed on an outer surface of the control module, thereby attaching the control module on a side wall of the grill body.

16. A method for implementing an electronic roasting system which comprises at least one roasting tool, a grill body supporting the at least one roasting tool, at least one mechanical unit driving the at least one roasting tool to rotate, a processing unit, an electrical control unit electrically coupled to the processing unit, and an information output/input unit electrically coupled to the processing unit, the method comprising steps of:
presetting a control information with relation to the at least one roasting tool by the information output/input unit; and
controlling the electrical control unit by the processing unit to drive the at least one mechanical unit to move, according to the preset control information, and then the movement of the at least one mechanical unit leads the at least one roasting tool to rotate.

17. The method of claim 16, wherein the preset control information comprises a rotation time of the at least one roasting tool and/or at least one automatic mode.

18. The method of claim 17, wherein the at least one automatic mode contains a total roasting time and the rotation time of the at least one roasting tool.

19. The method of claim 16, further comprising steps of:
sensing a heating temperature generated in the grill body by at least one temperature sensing unit;
the processing unit reading an information related to the heating temperature from the at least one temperature sensing unit via an electrical feedback control unit; and
a control parameter generating unit implementing or adjusting the control information by the processing unit according to the information of the heating temperature.

20. The method of claim 19, further comprising steps of:
the control parameter generating unit automatically programming to adjust an outflow volume of a combustible gas control valve disposed on the grill body.

21. A roasting tool, comprising:
a first mesh having a first side and a second side corresponding to the first side, and the second side having a first protruded structure; and
a second mesh having a third side and a fourth side corresponding to the third side, and the fourth side having a second protruded structure, a handle connected to the second protruded structure, and a ring disposed at the second protruded structure, wherein the first side and the third side are connected to each other, and the first protruded structure is inserted into the ring so as to combine the first mesh and the second mesh to be a flat layered mesh when the roasting tool is closed.

22. The roasting tool of claim 21, wherein an inner diameter of the ring is smaller than a size of the handle.

23. The roasting tool of claim 21, wherein the third side of the second mesh has a third protruded structure.
